(19) United States
(12) Patent Application Publication
(10) Pub. No.: US 2006/0026557 A1
(43) Pub. Date: Feb. 2, 2006

(54) Manipulating portlets

(75) Inventor: John Edward Petri, Lewiston, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/901,596

(22) Filed: Jul. 29, 2004

(51) Int. Cl. G06F 9/44

(52) U.S. Cl. 717/106

(57) ABSTRACT

A method, apparatus, system, and signal-bearing medium that, in an embodiment, create concrete configuration associated with a page based on an abstract personal configuration. Wrapper code is also created, and the wrapper code, the page, and the concrete configuration are sent to a client. When executed at the client, the wrapper code manipulates portlets associated with the page using the concrete code. The personal configuration allows portlets to be arranged and managed dynamically on a per-user basis. The wrapper code causes the portlets to be dragged, dropped, resized, overlapped, and hidden.

### FIELD

An embodiment of the invention generally relates to a computer network. In particular, an embodiment of the invention generally relates to dynamic portlet windowing.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware (such as semiconductors, integrated circuits, programmable logic devices, programmable gate arrays, and circuit boards) and software, also known as computer programs. Years ago, computers were isolated devices that did not communicate with each other. But, today computers are often connected in networks, and a user at one computer, often called a client, may wish to access information at multiple other computers, often called servers, via a network.

The popularity of distributed computing networks and network computing has increased tremendously in recent years, due in large part to growing business and consumer use of the public Internet and the subset thereof known as the “World Wide Web” (or simply the “Web”). But, other types of distributed computing networks, such as corporate intranets and extranets, are also increasingly popular. As solutions providers increasingly focus on delivering improved Web-based computing, many of the solutions that are developed are adaptable to other distributed computing environments. Thus, references herein to the Internet and Web are for purposes of illustration only and not of limitation.

The early Internet served primarily as a distributed file system in which users could request delivery of already-generated static documents. In recent years, however, the trend has been to add more and more dynamic and personalized aspects into the content that is served to requesters. One area where this trend is evident is in the increasing popularity of content frameworks, such as those commonly referred to as “portals” (or, equivalently, portal platforms, portal systems, or portal servers).

A portal is a type of content framework that is designed to serve as a gateway, or focal point, for end users to access an aggregation or collection of information and applications from many different sources. Portals are typically visual in nature and provide their users with a Web page known as a “portal page.” A portal page is often structured as a single overview-style page, which may provide links for the user to navigate to more detailed information. Alternatively, portal pages may be designed using a notebook paradigm, whereby multiple pages are available to the user upon selecting a tab for that page. Some experts predict that portal pages will become the computing “desktop” view of the future.

Portals may provide several services for Internet users, such as a search engine, a directory of Web sites, news and weather information, e-mail, stock quotes, links to chat rooms and shopping opportunities, directories such as phone and geographic directories, and other services. Some common general portals include Yahoo, America Online's AOL.com, Excite, and Lycos. In addition, many Internet service providers and companies offer their own branded portals to the Web for users of their Internet services. Portal sites allow the service provider to achieve large audiences and focus targeted messages, such as advertising, messages, corporate information, and other desired information, to the users each time they access the Web using the portal.

The portal typically provides personalization, single sign-on, and content aggregation from different server sources. Thus, the portal hosts the presentation layer of information systems. Content aggregation is the process of integrating content from different sources within a Web page, which is typically performed by a portal program. An example of a portal program is WebSphere, which is available from International Business Machines Corp. of Armonk, N.Y., but any appropriate portal program may be used. A portal may have sophisticated personalization features to provide customized content to users. Portal pages may have different sets of portlets, which may create content for different users.

A portlet is a web component, managed by a portlet container, that processes requests and generates dynamic content. Portals use portlets as pluggable user interface components that provide a presentation layer to information systems. The term “portlet,” as commonly used, often refers to both the visual sections of a portal page, as well as to the program code used to obtain and aggregate the content therein for display in the visual sections. Thus, a portlet should be understood to have at least two manifestations: (1) a visual portlet displayed as part of a portal page; (2) and a portlet program that includes the program code for obtaining the content displayed in the visual portlet.

The portal page itself often represents a complete markup document and aggregates several portlet windows. In addition to the portlets, the portal page may also consist of navigation areas and banners. The portlet window may consist of a title bar with the portlet's title, decorations, and the content provided by the portlet. The decorations can include buttons to change the portlet's window state and mode. Portals and portlets are described in JSR (Java Specification Request) 168, which is hereby incorporated by reference. But, portals and portlets may be used with other specifications, and are not restricted to Java.

Clients typically interact with portlets via a request/response paradigm implemented by the portal. Users typically interact with content produced by portlets by, for example, following links or submitting forms, resulting in portlet actions being received by the portal, which then forward to the portlets targeted by the user's interactions.

A significant problem when designing Web portals is deciding how to efficiently use screen real estate when managing the portlets, which appear to the user as the portal's windows. This problem is especially difficult when the portal is designed to represent a complex application that may require several portlets interacting with each other on the same Web page. Current application server technology is lacking when it comes to dynamically managing complex portals. Websphere Portal Server (WPS) currently provides technology that allows multiple portlets to coexist and communicate on the same page in a portal. Unfortunately, the arrangement and runtime management of these portlets is static, meaning that each portlet that is placed on a page occupies a certain amount of screen real estate that cannot be overlapped, reused, or moved from a pre-set position. At most, using current technology, portlets may be minimized, maximized, and restored. Thus, when multiple portlets reside on the same page, the user is restricted in the operations that may be performed against the portlets.

Without a better way to manage portlets, users of complex portals with multiple portlets will continue to experience difficulty managing screen real estate.

### SUMMARY

A method, apparatus, system, and signal-bearing medium are provided that, in an embodiment, create concrete configuration associated with a page based on an abstract personal configuration. Wrapper code is also created, and the wrapper code, the page, and the concrete configuration are sent to a client. When executed at the client, the wrapper code manipulates portlets associated with the page using the concrete code. The personal configuration allows portlets to be arranged and managed dynamically on a per-user basis. The wrapper code causes the portlets to be dragged, dropped, resized, overlapped, and hidden.

### BRIEF DESCRIPTION OF THE DRAWING

FIG. 1 depicts a block diagram of an example system for implementing an embodiment of the invention.

FIG. 2 depicts an example user interface for interacting with a portal and the portal's portlets, according to an embodiment of the invention.

FIG. 3 depicts a block diagram of an example data structure used for managing portlets, according to an embodiment of the invention.

FIG. 4 depicts a flowchart of example processing for managing portlets, according to an embodiment of the invention.

### DETAILED DESCRIPTION

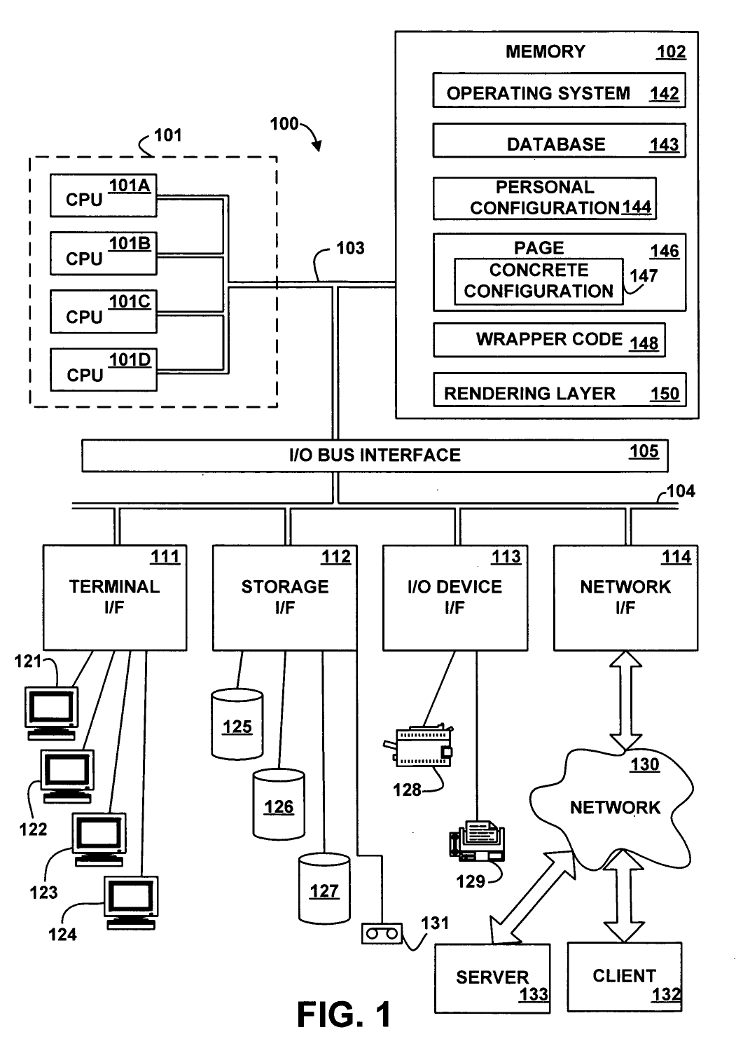

Referring to the Drawing, wherein like numbers denote like parts throughout the several views, FIG. 1 depicts a high-level block diagram representation of a computer system 100 connected to clients 132 and servers 133 via a network 130, according to an embodiment of the present invention. The computer system 100 acts as a server to the clients 132. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes an operating system 142, a database 143, an abstract personal configuration 144, a page 146, wrapper code 148, and a rendering layer 150. Although the operating system 142, the database 143, the abstract personal configuration 144, the page 146, the wrapper code 148, and the rendering layer 150 are illustrated as being contained within the memory 102 in the computer system 100, in other embodiments some or all of them may be on different computer systems, e.g., the server 133, and may be accessed remotely, e.g., via the network 130.

The computer system 100 may use virtual addressing mechanisms that allow the programs of the computer system 100 to behave as if they only have access to a large, single storage entity instead of access to multiple, smaller storage entities. Thus, while the operating system 142, the database 143, the abstract personal configuration 144, the page 146, the wrapper code 148, and the rendering layer 150 are all illustrated as being contained within the memory 102 in the computer system 100, these elements are not necessarily all completely contained in the same storage device at the same time.

The operating system 142 may include low-level code to manage the resources of the computer system 100, such as memory, processing time, disk space, and peripheral devices. The operating system 142 is the foundation on which applications, such as the rendering layer 150, are built. The operating system 142 may be implemented via OS/400, AIX, or Linux, but in other embodiments any appropriate operating system may be used.

The database 143 is a collection of data with a given structure for accepting, storing, and providing data. The database 143 may store layout information of the page 146, for example using an XML (Extensible Markup Language) grammar. In various embodiments the database 143 may be a relational database or a non-relational database. In other embodiments, the database 143 may be a flat file or any other appropriate data repository. Although the database 143 is illustrated as being contained within the computer system 100, in another embodiment the database 143 is stored on the server 133 and is accessed remotely or is distributed across multiple servers 133.

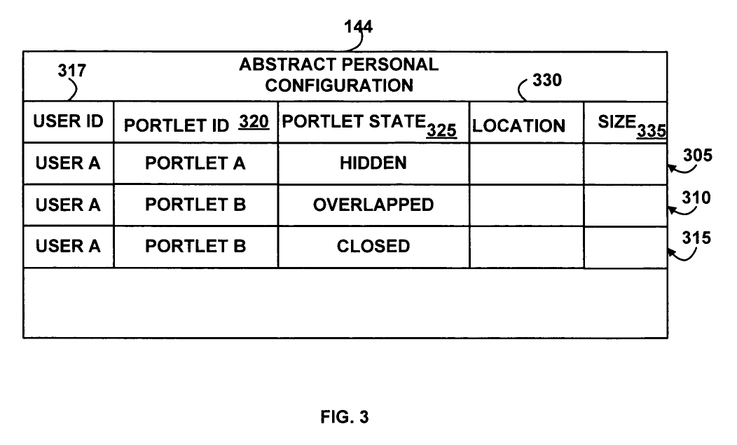

The abstract personal configuration 144 is associated with the user who logged into the portal associated with the page 146. The abstract personal configuration 144 describes the configuration and orientation of the portlets that are associated with the display of the page 146 at the client 132. Although the abstract personal configuration 144 is illustrated as being separate from the database 143, in another embodiment the abstract personal configuration 144 may be stored in the database 143. The abstract personal configuration 144 is further described below with reference to FIG. 3.

The page 146 may be a document that includes data and control tags that describe how the data is to be formatted for display at the client 132. In an embodiment, the page 146 may be implemented via the HTML (Hypertext Markup Language), but in other embodiments any appropriate markup language protocol may be used. The page 146 may be sent from the server 100 to the client 132. The client 132 may interpret the control tags in the page 146 to format and display the data. The client 132 may use, e.g., an unillustrated browser to retrieve and display the page 146. The page 146 includes a concrete configuration 147, but in other embodiments the concrete configuration 147 may be associated with the page 146. The page 146 may include associated files for graphics and scripts.

The wrapper code 148 manages the dynamic configuration (e.g., moving, hiding, dragging, dropping, and resizing) of the portlets on the screen at the client 132. In various embodiments, the wrapper code 148 may be implemented using DHTML (Dynamic Hypertext Markup Language), HTML, JavaScript, CSS (Cascading Style Sheets), or any other appropriate protocol. The wrapper code 148 is generated at the server 100 by the rendering layer 150. The wrapper code 148 is downloaded to the client 132, where the wrapper code 148 executes.

The rendering layer 150 calls a plug-in to create the wrapper code 148 and transforms the abstract personal configuration 144 into the concrete configuration 147 associated with the page 146. Since the rendering layer 150 deals with the abstract personal configuration 144, different plug-ins may be used to generate the actual page 146 and portlet markup/code that is sent to the client 132 and used by the end user. This is powerful in the fact that the window management code (i.e., the wrapper code 148 and concrete configuration 147) can be different based on any number of factors, which might include browser version, browser type (e.g., a PDA or desktop browser), or user preference. In an embodiment, HTML can be generated. In another embodiment, WML (Wireless Markup Language) can be generated. In another embodiment, Java applets can be generated. The rendering layer 150 further manages communication to the database 143 and sends the wrapper code 148, the page 146, and the concrete configuration data 147 to the client 132 in response to a request.

The particular wrapper code 148 that is generated by the rendering layer 150 may, in an embodiment, be the same for all pages and portlets that use it. The wrapper code 148 is a program that runs on the client 132 to control the dynamic behavior of portlets such as dragging/dropping, resizing, and hiding.

The wrapper code 148 takes input to dictate it's behavior, which is how the concrete configuration 147 is used at the client 132. The rendering layer creates the concrete configuration 147 by transforming the abstract personal configuration 144 and sends the concrete configuration 147 to the client 132 with the wrapper code 148. The concrete configuration 147 will vary depending on the wrapper code 148 used, and is, in an embodiment, closely tied to the wrapper code 148. In an embodiment where the wrapper code 148 is DHTML (HTML, JavaScript, and Cascading Style Sheets), the concrete configuration 147 may be represented as a set of JavaScript variables. In another embodiment where the wrapper code 148 is DHTML, the concrete configuration 147 may be represented as XML fragments. In other embodiments, the concrete configuration 147 may be a delimited string of values. In yet other embodiments, the concrete configuration 147 is the actual form of data that is acted upon by the wrapper code 148 at runtime at the client 132. A concrete configuration 147 will exist for each portlet on the page. When the user interacts with a dynamic portlet, the wrapper code 148 references the concrete configuration 147 associated with that portlet, and sets/retrieves values appropriately (e.g., the wrapper code 148 sets new x, y position, width, and height). When the current concrete configuration 147 is saved back to the server, a reverse transformation takes place. The reverse transformation changes the concrete configuration 148 back to the abstract personal configuration 144 before storing it away.

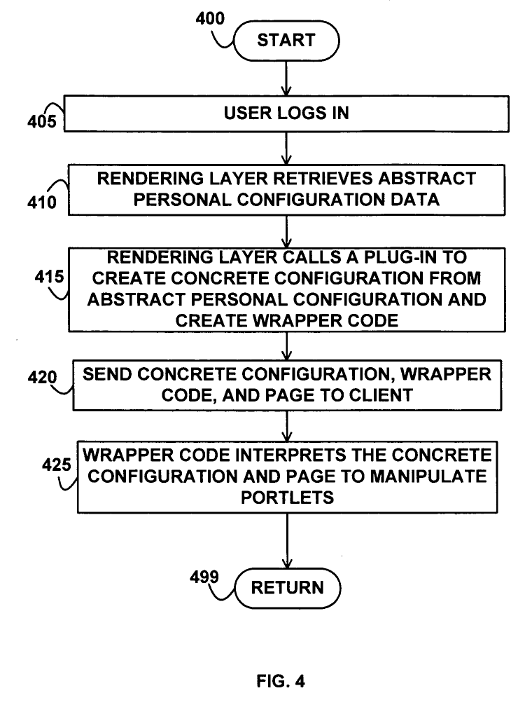

In an embodiment, the rendering layer 150 includes instructions capable of executing on the processor 101 or statements capable of being interpreted by instructions executing on the processor 101 to perform the functions as further described below with reference to FIG. 4. In another embodiment, the rendering layer 150 may be implemented in microcode. In yet another embodiment, the rendering layer 150 may be implemented in hardware via logic gates and/or other appropriate hardware techniques, in lieu of or in addition to a processor-based system.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed. The storage interface unit 112 may also support other types of devices, such as a tape device 131, an optical device, or any other type of storage device.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types.

The network interface 114 provides one or more communications paths from the computer system 100 to other digital devices and computer systems; such paths may include, e.g., one or more networks 130. In various embodiments, the network interface 114 may be implemented via a modem, a LAN (Local Area Network) card, a virtual LAN card, or any other appropriate network interface or combination of network interfaces.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a firewall, router, Internet Service Provider (ISP), personal computer, portable computer, laptop computer, notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3× specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet.

In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present, and the client 132 and the server 133 need not be connected to the same network. For example, in an embodiment, the clients 132 are connected to the computer system 100 via the Internet while the server 133 is connected to the computer system 100 via a LAN.

The client 132 and the server 133 may further include some or all of the hardware components previously described above for the computer system 100. Although only one client 132 and one server 133 are illustrated, in other embodiments any number of clients and servers may be present. The client 132, or a user of the client 132, desires to send requests to the servers 100, to receive the page 146 from the server 100, and to manipulate the portlets associated with the page 146.

It should be understood that FIG. 1 is intended to depict the representative major components of the computer system 100, the network 130, the clients 132, and the servers 133 at a high level, that individual components may have greater complexity than represented in FIG. 1, that components other than, fewer than, or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), CD-RW, or diskette; or

(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs, as described hereinafter, may be identified based upon the application for which they are implemented, in a specific embodiment of the invention. But, any particular program nomenclature that follows is used merely for convenience, and thus embodiments of the present invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

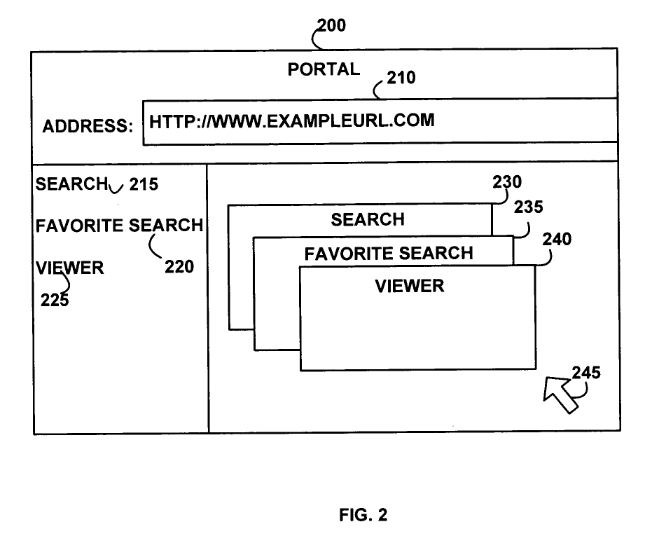

FIG. 2 depicts an example user interface 200 for interacting with a portal and the portal's portlets, which are implemented via the page 146, according to an embodiment of the invention. The user interface 200 includes selection buttons 215, 220, and 225 and portlets 230, 235, and 240, but in other embodiments the user interface 200 may include any number and type of user interface elements and portlets with any appropriate data.

Selection of the button 215 on the user interface 200 activates the portlet 230. Selection of the button 220 on the user interface 200 activates the portlet 235. Selection of the button 225 on the user interface 200 activates the portlet 240. The portlets 230, 235, and 240 may be operated on using various functions, such as dynamic dragging, dropping, moving, resizing, overlapping, and hiding, as further described below with reference to FIG. 4. The user may initiate such operations via the pointer 245, but in other embodiments any appropriate user interface element may be used to interact with the portals 230, 235, and 240. In various embodiments, the pointer 245 may be controlled by a mouse, touchpad, joystick, trackball, or any other type of pointing device.

FIG. 3 depicts a block diagram of an example data structure for the abstract personal configuration 144, which is used for managing portlets, according to an embodiment of the invention. The portal administrator or a user with proper authority creates the initial abstract personal configurations 144 (e.g., page and portlet definitions) at design or deploy time. The abstract personal configurations 144 are created per user or user group, according to enterprise roles. Each page and portlet in the definition may be named within a namespace, so they can be uniquely identified. The initial abstract personal configuration 144 identifies attributes of the portlets. In one possible embodiment of the invention, the abstract personal configuration 144 may be represented as XML, but in other embodiments any appropriate protocol may be used.

The abstract personal configuration 144 includes records 305, 310, and 315, but in other embodiments any number of records with any appropriate data may be present. Each of the records 305, 310, and 315 includes a user identifier field 317, a portlet identifier field 320, a portlet state field 325, a location field 330, and a size field 335, but in other embodiments more or fewer fields may be present.

The user identifier field 317 identifies the user associated with the record. By associating users with records, the portlets may be personalized on a per-user basis. The portlet identifier field 320 includes an identifier of the portlet associated with the record, such as one of the portlets 230, 235, and 240, as previously described above with reference to FIG. 2. The portlet state field 325 indicates the state of the portlet associated with the record, such as “hidden,” “overlapped,” or “closed.” A portlet state of hidden indicates that the associated portlet is hidden or not viewable. A portlet state of overlapped indicates that the associated portlet is partially or completely overlapped on the screen with another portlet. A portlet state of closed indicates that the associated portlet is closed or not currently active on the screen. In other embodiments various other states, such as whether the portlet is dynamic, static, or resizeable may be used, as appropriate.

The location field 330 indicates the location on the screen of the portlet that is associated with the record in the abstract personal configuration 144. The size field 335 indicates the size on the screen of the portlet that is associated with the record in the abstract personal configuration 144. In various embodiments, the location field 330 and the size field 335 may indicate the current location and size, respectively, or the allowed location and size.

The following is a very simple example of the abstract personal configuration 144, but in other embodiments any appropriate data may be used:

<PageConfig id=“d237_fl09SearchPage”>

<WindowConfig id=“d237_fl09SearchPortlet” type=“static” zIndex=“1” x=“20”

y=“25” w=“200” h=“300” />

<WindowConfig id=“d237_fl09ViewerPortlet” type=“dynamic” zIndex=“2”

x=“30” y=“25” w=“300” h=“400” state=“visible” resizable=“true” />

<WindowConfig id=“d237_fl09FavoritesPortlet” type=“dynamic” zIndex=“1”

x=“20” y=“20” w=“160” h=“300” state=“hidden” resizable=“true” />
</PageConfig>

FIG. 4 depicts a flowchart of example processing for managing portlets, according to an embodiment of the invention. Control begins at block 400. Control then continues to block 405 where the user at the client 132 logs into the portal that is associated with the page 146, which in an embodiment is the home page of the user. But, in other embodiments, the user may log into, access, or retrieve any appropriate page 146.

Control then continues to block 410 where, in response to the user access the page 146, the rendering layer 150 retrieves the abstract personal configuration data 144 that is associated with the user who logged into the portal associated with the page 146, as previously described above with reference to block 405. In an embodiment, the rendering layer 150 may retrieve the abstract personal configuration data 144 from the database 143, but in other embodiments the rendering layer 150 may retrieve the abstract personal configuration data 144 associated with the user from any appropriate data repository.

Control then continues to block 415 where the rendering layer 150 calls a plug-in to create the concrete configuration 147 based on the abstract personal configuration 144 and the wrapper code 148. In an embodiment, the plug-in may be associated with the user at the client 132. In another embodiment, the plug-in may be part of the rendering layer 150 and not associated with any user. The rendering layer 150 creates the concrete configuration 147 and the wrapper code 148, so that they are executed, interpreted, or accessed at the client 132, they are capable of moving, dragging, dropping, resizing, overlapping, and/or hiding the portlets, such as the portlets 230, 235, and 240, without accessing the server 100.

In an embodiment, the rendering layer 150 may use an XSLT (Extensible Stylesheet Language Transformations) engine and render beans to create the concrete configuration 147 and the wrapper code 148. XSLT is a language for transforming XML (Extensible Markup Language) documents into other XML documents. In an embodiment, XSLT is used as a part of XSL (Extensible Stylesheet Language), which is a stylesheet language for XML. In addition to XSLT, XSL includes an XML vocabulary for specifying formatting. XSL specifies the styling of an XML document by using XSLT to describe how the document is transformed into another XML document that uses the formatting vocabulary. In another embodiment, XSLT may be used independently of XSL. But, in other embodiments any appropriate language, protocol, or engine may be used.

Control then continues to block 420 where the rendering layer 150 sends the page 146, the concrete configuration 147, and the wrapper code 148 to the client 132 associated with the user that logged into the portal. In an embodiment, the wrapper code 148 includes a theme and skin for the concrete configuration 147 associated with the page 146.

A theme is an interchangeable front end for a portal and determines the global appearance of all pages in a place, which ensures visual consistency. The theme controls elements in the portal, such as the banner, the navigational structure, the colors and fonts, the available portlet skins, and the look and feel of the user interface 200. The theme consists of resources, such as files, style sheets, and images.

A skin is an interchangeable front end for a portlet and defines the frame that is displayed around a portlet. The skin controls elements in the portlet, such as the minimize and maximize icons, the title bar, and the background color or pattern of the portlet.

Control then continues to block 425 where the wrapper code 148 interprets the concrete configuration 147 and the page 146 to manipulate the portlets, such as the portlets 230, 235, and 240, which were previously described above with reference to FIG. 2. In various embodiments, the wrapper code 148 manipulates the portals by moving, dragging, dropping, resizing, overlapping, and hiding the portlets, such as the portlets 230, 235, and 240, without accessing the server 100. The wrapper code 148 performs the moving, dragging, dropping, moving, resizing, overlapping, and hiding of the portlets in response to user interface selections at the client 132, such as events from a pointing device, such as a mouse, touchpad, or trackball.

Control then continues to block 499 where the logic of FIG. 4 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention. But, other embodiments may be utilized, and logical, mechanical, electrical, and other changes may be made to the described embodiments without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the embodiments of the invention may be practiced without these specific details. In other instances, well-known circuits, structures, and techniques have not been shown in detail in order not to obscure embodiments of the invention.

What is claimed is:

1. A method comprising:
creating wrapper code;
creating a concrete configuration associated with a page based on an abstract personal configuration; and
sending the wrapper code the page, and the concrete configuration to a client, wherein the wrapper code when executed at the client manipulates portlets associated with the page based on the concrete configuration.

2. The method of claim 1, wherein the creating further comprises:
creating the wrapper code and the concrete configuration to drag and drop the portlets.

3. The method of claim 1, wherein the creating further comprises:
creating the wrapper code and the concrete configuration to resize the portlets.

4. The method of claim 1, wherein the creating further comprises:
creating the wrapper code and the concrete configuration to hide the portlets.

5. An apparatus comprising:
means for creating wrapper code;
means for creating a concrete configuration associated with a page based on a personal configuration, wherein the personal configuration specifies a location of portlets associated with the page; and
means for sending the wrapper code, the page, and the concrete configuration to a client, wherein the wrapper code when executed at the client manipulates the portlets based on the concrete configuration.

6. The apparatus of claim 5, wherein the means for creating further comprises:
means for creating the wrapper code and the concrete configuration to move the portlets.

7. The apparatus of claim 5, wherein the means for creating further comprises:
means for creating the wrapper code and the concrete configuration to overlap at least some of the portlets.

8. The apparatus of claim 5, wherein the means for creating further comprises:
means for creating the wrapper code and the concrete configuration to hide the portlets.

9. A signal-bearing medium encoded with instructions, wherein the instructions when executed comprise:
creating wrapper code;
creating a concrete configuration in a page based on a personal configuration, wherein the personal configuration specifies a location and size of portlets associated with the page; and
sending the wrapper code, the page, and the concrete configuration to a client, wherein the wrapper code when executed at the client manipulates the portlets based on the concrete configuration.

10. The signal-bearing medium of claim 9, wherein the creating further comprises:
creating the wrapper code and the concrete configuration to drag and drop the portlets.

11. The signal-bearing medium of claim 9, wherein the creating further comprises:
creating the wrapper code and the concrete configuration to resize the portlets.

12. The signal-bearing medium of claim 9, wherein the creating further comprises:
creating the wrapper code and the concrete configuration to hide the portlets.

13. A computer system comprising:
a processor; and
memory encoded with instructions, wherein the instructions when executed on the processor comprise:
creating wrapper code;
creating a concrete configuration associated with a page based on a personal configuration, wherein the personal configuration specifies a location and size of portlets associated with the page, and
sending the wrapper code and the page to a client, wherein the wrapper code when executed at the client the manipulates the portlets based on the concrete configuration in response to user interface events.

14. The computer system of claim 13, wherein the creating further comprises:
creating the wrapper code and the concrete configuration to drag and drop the portlets.

15. The computer system of claim 13, wherein the creating further comprises:
creating the wrapper code and the concrete configuration to resize the portlets.

16. The computer system of claim 13, wherein the creating further comprises:
creating the wrapper code and the concrete configuration to hide the portlets.

17. A method for configuring a computer, comprising:
configuring the computer to create wrapper code;
configuring the computer to create a concrete configuration associated with a page based on a personal configuration; and
configuring the computer to send the wrapper code, the page, and the concrete configuration to a client, wherein the wrapper code when executed at the client manipulates portlets associated with the page based on the concrete configuration.

18. The method of claim 17, wherein the configuring the computer to create further comprises:
configuring the computer to create the wrapper code and the concrete configuration to drag and drop the portlets.

19. The method of claim 17, wherein the configuring the computer to create further comprises:
configuring the computer to create the wrapper code and the concrete configuration to resize the portlets.

20. The method of claim 17, wherein the configuring the computer to create further comprises:
configuring the computer to create the wrapper code and the concrete configuration to hide the portlets.
